(19) United States
(12) Patent Application Publication
(10) Pub. No.: US 2016/0282165 A1
(43) Pub. Date: Sep. 29, 2016

(54) Improved Compressed Gas Cylinder

(71) Applicant: LUXFER GAS CYLINDERS LIMITED, Salford Greater Manchester (GB)

(72) Inventor: Tim Allen, Wimborne Minster Dorset (GB)

(21) Appl. No.: 15/033,540

(22) PCT Filed: Oct. 31, 2014
(86) PCT No.: PCT/GB2014/053246

§ 371 Date: Apr. 29, 2016

(30) Foreign Application Priority Data
Nov. 1, 2013 (GB) 1319373.5

(51) Int. Cl. G01F 22/02; F16K 37/00; F17C 13/02

(52) U.S. Cl. CPC G01F 22/02; F17C 13/025; F17C 13/026; F16K 37/00; F17C 2221/011; F17C 2250/0404; F17C 2250/034; F17C 2270/02; F17C 2250/0473

(57) ABSTRACT

The compressed gas cylinder (1) is suitable for use in delivering medical gas therapy to ambulatory patients. The compressed gas cylinder (1) has a hollow main body (2) in which therapeutic gas is stored under pressure; a cylinder head (3); a gas outlet (4); and a display (6). The display (6) provides estimates of the time remaining before full depletion of the gas within the cylinder (1). Estimates of the time remaining are based upon estimates of the amount of gas remaining in the gas cylinder (1). However, temperature variation and fluctuations in actual measurements can cause substantial errors when estimating the amount of gas remaining. The improved gas cylinder (1) reduces these errors by calculating time remaining based upon two values for the amount of gas remaining that differ by at least a predetermined minimum.

### FIELD OF THE INVENTION

The present invention relates to an improved compressed gas cylinder; to an electronic gauge for use with a compressed gas cylinder; and, to a method of monitoring gas usage/gas remaining in a cylinder. Preferably, but not exclusively, the present invention is suitable for use with compressed gas cylinders suitable for use in delivering pharmaceutical gases such as, but not limited to, oxygen. The present invention is particularly suited, but not exclusively, to lightweight compressed gas cylinders which enable patients, reliant upon regular or continuous gas therapy, to remain ambulatory.

### DESCRIPTION OF THE RELATED ART

Some medical treatments involve the use of gases that are inhaled by the patient. Particularly in the case of patients having chronic but stable conditions requiring regular or continuous treatment, portable lightweight compressed gas cylinders can be used enabling such patients to receive the treatment they need outside of a treatment centre, for example in the patient's own home and elsewhere. Whether within a hospital/care home environment or in the patient's own home it is important that the amount of medical gas a patient receives is monitored. It is also important that during use, the amount of gas remaining in a cylinder is monitored so that either the patient or those supervising treatment are aware of when the medical gas in the cylinder is about to run out.

As an example of the above, chronic obstructive pulmonary disease, (COPD) is a disabling respiratory disease and oxygen therapy is one of the few effective therapies known to increase survival for people with COPD. However, survival is only improved in those who use the oxygen as prescribed and it is known that many patients with COPD do not use their oxygen as prescribed and so do not receive the health benefits. Ambulatory oxygen plays a key role in enabling patients on long-term oxygen to adhere to their prescription but many patients remain housebound due to the size and weight of the oxygen systems prescribed and also due to fears of the oxygen suddenly running out when they are away from home because conventional gauges are considered too unreliable to be trusted. Some patients are also known to have difficulties in reading conventional cylinder gauges.

In U.S. Pat. No. 7,114,510 a valve integral with a handle for use with compressed gas cylinders is described. The valve handle includes sensors for sensing the opening and closing of the valve, a timer for monitoring the duration the valve remains open and a memory in which this data is stored. The data stored in the memory can be subsequently downloaded for the purposes of determining usage and/or billing reports. However, U.S. Pat. No. 7,114,510 does not offer any solution for monitoring the amount of gas remaining in a cylinder.

U.S. Pat. No. 3,875,801 is an early example of a gauge used to indicate time to depletion of a gas used by SCUBA divers. The gauge monitors gas pressure within the cylinder and the rate of gas depletion to determine estimated time duration to full depletion of the gas. U.S. Pat. No. 3,875,801 acknowledges that the water temperature during a SCUBA dive is unlikely to vary significantly and so the effect of any temperature variation on the accuracy of the gauge is not addressed.

In U.S. Pat. No. 7,104,124 a method and system for indicating the duration of gas remaining in a gas cylinder supply is described. The method and system described in U.S. Pat. No. 7,104,124 monitors the gas pressure at the outlet of the gas cylinder and the rate of depletion to estimate time duration to full depletion of the gas.

A time remaining display assembly is described in US 2012/0080103 for use with a gas regulator. A pressure gauge on the cylinder indicates the pressure of gas remaining in the cylinder and the gas regulator on the outlet of the cylinder controls the rate of flow of gas from the cylinder. With US 2012/0080103 the time remaining display assembly adapts the cylinder pressure gauge to indicate time duration to full gas depletion through the use of a plurality of different time scales. Each time scale is related to a particular gas flow rate and so each time scale is related to a particular regulator setting. Adjustment of the regulator automatically causes a different time scale to be selected so that the pressure gauge indicates the time remaining with respect to the current regulator setting.

Although it is well known that gas pressure within a fixed volume varies with respect to temperature, this variable is rarely or inadequately accounted for when calculating time duration to full gas depletion for pressurised gas cylinders.

### SUMMARY OF THE INVENTION

The present invention seeks to address problems arising with providing information pertaining to time duration to full gas depletion for pressurised gas cylinders and seeks to improve the accuracy of such information.

The present invention also seeks to provide information pertaining to time duration to full gas depletion which takes account of effects of temperature on this information.

Thus, the present invention provides an electronic gauge for use with a compressed gas cylinder, the electronic gauge comprising: one or more processing units adapted to receive gas pressure measurement from a gas pressure sensor and temperature measurements from a temperature sensor; and a display interface in communication with the one or more processing units and adapted for communication with a display, wherein the one or more processing units are adapted to perform the following steps:
i) determining a plurality of gas remaining values for the amount of gas remaining in the compressed gas cylinder each gas remaining value being based on a plurality of gas pressure measurements and one or more temperature measurements and
ii) determining a time remaining until substantially all gas in the compressed gas cylinder is depleted based upon two gas remaining values, and communicating the determined time remaining to the display interface for the display,
   wherein, when determining the time remaining until substantially all gas in the cylinder is depleted, the one or more processing units are adapted to use two gas remaining values which differ by at least a minimum difference threshold.

Alternatively the present invention provides an electronic gauge for use with a compressed gas cylinder, the electronic gauge comprising: one or more processing units adapted to receive gas pressure measurement from a gas pressure sensor and temperature measurements from a temperature sensor; and a display interface in communication with the one or more processing units and adapted for communication with a display wherein the one or more processing units are adapted to perform the following steps: determining a plurality of gas remaining values for the amount of gas remaining in the compressed gas cylinder each gas remaining value being based on a plurality of gas pressure measurements and one or more temperature measurements and determining a time remaining until substantially all gas in the compressed gas cylinder is depleted based upon two gas remaining values, and communicating the determined time remaining to the display interface for the display, wherein, when determining the time remaining until substantially all gas in the cylinder is depleted, the one or more processing units are not constrained to use two gas remaining values with a predetermined elapsed time between them.

In a further alternative the present invention provides an electronic gauge for use with a compressed gas cylinder, the electronic gauge comprising: one or more processing units; a gas pressure sensor in communication with the one or more processing units; a temperature sensor in communication with the one or more processing units; a display interface in communication with the one or more processing units and adapted for communication with a display; and program storage in which is stored instructions to be performed by the one or more processing units, the instructions embodying the following steps: determining a plurality of gas remaining values for the amount of gas remaining in the compressed gas cylinder each gas remaining value being based on a plurality of gas pressure measurements and one or more temperature measurements and determining a time remaining until substantially all gas in the compressed gas cylinder is depleted based upon two gas remaining values, and communicating the determined time remaining to the display interface for the display, wherein, when determining the time remaining until substantially all gas in the cylinder is depleted, the one or more processing units are adapted to use two gas remaining values which differ by at least a minimum difference threshold whereby selection of the gas remaining values to be used in determining the gas time remaining is not constrained to two gas remaining values with a predetermined elapsed time between them.

In a preferred embodiment the electronic gauge further comprises one or more memories in communication with the one or more processing units, the one or more memories including at least one buffer in which gas remaining values determined by the one or more processing units are temporarily stored. Ideally the at least one buffer is a FIFO buffer.

In a further preferred embodiment the one or more processing units are adapted to determine or the program storage includes instructions for determining the time remaining until substantially all gas is depleted using two gas remaining values which differ by at least a predetermined gas difference threshold.

In a particularly preferred embodiment the one or more processing units are adapted to determine or the program storage includes instructions for determining a maximum difference threshold and for identifying a pair of gas remaining values for use in determining the time remaining, the pair of gas remaining values differing by an amount which exceeds the minimum difference threshold and does not exceed the maximum difference threshold.

The one or more processing units may be adapted to determine or the program storage includes instructions for determining gas remaining values using temperature values determined by the one or more processing units, the temperature values being based on temperature measurements, and using pressure values determined by the one or more processing units, each pressure value being an average of a plurality of gas pressure measurements.

In a particularly preferred embodiment each temperature value is determined by applying to a plurality of temperature measurements a function which is substantially matched to the response to a temperature difference of a thermal body consisting of the cylinder and the compressed gas within it. Each temperature value may be determined by applying to the plurality of temperature measurements a filter having a response in the time domain that is substantially matched to the response to a temperature difference of the thermal body consisting of the cylinder and the compressed gas within it.

The electronic gauge may further comprise a first data port in communication with the one or more processing units and adapted for communication with a gas pressure sensor.

Also the electronic gauge may further comprise a temperature sensor or a second data port in communication with the one or more processing units and adapted for communication with a temperature sensor.

The electronic gauge may further comprise a wireless communication device for communicating at least some of the information determined by the one or more processing units to a remote receiver. The wireless communication device is preferably adapted to communicate using the Bluetooth™ protocol.

The electronic gauge may also further comprise an alarm wherein the one or more processing units are adapted to trigger the alarm when the gas in the cylinder is close to being fully depleted i.e. the time remaining is at least less than a predetermined time remaining threshold or the gas remaining is at least less than a predetermined gas remaining threshold.

In a separate aspect the present invention provides a compressed gas cylinder comprising a hollow main body in which is stored a gas under greater than atmospheric pressure; a cylinder gas outlet; a regulator valve for controlling the flow of gas from the hollow main body to the gas outlet; an electronic gauge as described above and a display for displaying at least the time remaining until substantially all gas is depleted determined by the electronic gauge.

Optionally the compressed gas cylinder further comprises a valve sensor for monitoring at least adjustment of the regulator valve.

Also the compressed gas cylinder may include a gas pressure sensor for recording gas pressure measurements within the main body and/or a temperature sensor for recording temperature measurements.

In a yet further aspect the present invention provides a method of calculating time remaining until substantially all gas in a compressed gas cylinder is depleted, the method comprising the steps of: (i) measuring on a plurality of temporally spaced occasions the pressure of gas in the cylinder; (ii) measuring on a plurality of temporally spaced occasions the temperature; (iii) determining gas remaining values for the amount of gas remaining within the cylinder, each gas remaining value being determined using a plurality of gas pressure measurements and at least one temperature measurement; (iv) determining values of time remaining until substantially all gas in the cylinder is depleted, each gas time remaining value being determined using two of the determined gas remaining values; and (v) displaying the determined gas time remaining values, wherein in step (iv) the two determined gas remaining values used in determining the time remaining value differ in value by at least a minimum difference threshold.

Alternatively the present invention provides a method of calculating time remaining until substantially all gas in a compressed gas cylinder is depleted, the method comprising the steps of: (i) measuring on a plurality of temporally spaced occasions the pressure of gas in the cylinder; (ii) measuring on a plurality of temporally spaced occasions the temperature; (iii) determining gas remaining values for the amount of gas remaining within the cylinder, each gas remaining value being determined using a plurality of gas pressure measurements and at least one temperature measurement; (iv) determining values of time remaining until substantially all gas in the cylinder is depleted, each gas time remaining value being determined using two of the determined gas remaining values; and (v) displaying the determined gas time remaining values, wherein in step (iv) selection of the two gas remaining values used in determining the time remaining value is not constrained to gas remaining values with a predetermined elapsed time between them.

Preferably each gas remaining value is determined using a temperature value and a gas pressure value and the method further comprises the steps of:

determining a temperature value based upon a plurality of temperature measurements; and

determining a gas pressure value based upon an average of a plurality of gas pressure measurements.

In a particularly preferred embodiment each temperature value is determined by applying to the plurality of temperature measurements a function which is substantially matched to the response to a temperature difference of a thermal body consisting of the cylinder and the compressed gas within it. Ideally each temperature value is determined by applying to the plurality of temperature measurements a filter having a response in the time domain that is substantially matched to the response to a temperature difference of the thermal body consisting of the cylinder and the compressed gas within it.

Reference herein to a variable time period is to be understood as reference to the electronic gauge and its method of calculating time remaining which permits the time period bridged by two or more gas pressure measurements used in determining a first time remaining value to be different to the time period bridged by two or more gas pressure measurements used in determining a subsequent separate time remaining value. Moreover, this applies irrespective of whether or not the time interval between individual gas measurements being recorded is fixed or variable.

With the present invention an electronic gauge and a method of calculating time remaining is provided which are capable of determining more accurately and more efficiently (in terms of the use of computing resources) time remaining values for the amount of gas remaining in a pressurised cylinder. Furthermore, changes in environmental temperature which could affect the accuracy of the measurements of gas pressure are mitigated when calculating time remaining to full gas depletion.

The present invention therefore addresses a problem that can arise for example for patients who have active lifestyles and who use lightweight compressed gas cylinders. With conventional gas cylinder gauges that provide information on time remaining to full gas depletion, were the patient to carry their gas cylinder between two environments at different temperatures, e.g. between a warmed house and the outdoors on a cold day, information on time remaining to full gas depletion for that cylinder is likely to be inaccurate. With the present invention the effects of such temperature fluctuations are accommodated so that more accurate information on time remaining may be provided.

### BRIEF DESCRIPTION OF THE DRAWINGS

An embodiment of the present invention will now be described by way of example only with reference to the accompanying drawings, in which:

FIG. 1 illustrates a lightweight compressed gas cylinder in accordance with the present invention;

FIG. 2 is a functional diagram of an electronic gauge and peripherals for use in the compressed gas cylinder of FIG. 1;

FIG. 3 is a flow diagram of a first methodology for calculating time remaining to full gas depletion in accordance with the present invention; and

FIG. 4 is a flow diagram of an alternative methodology for calculating time remaining to full gas depletion also in accordance with the present invention

### DETAILED DESCRIPTION OF EXEMPLARY EMBODIMENTS

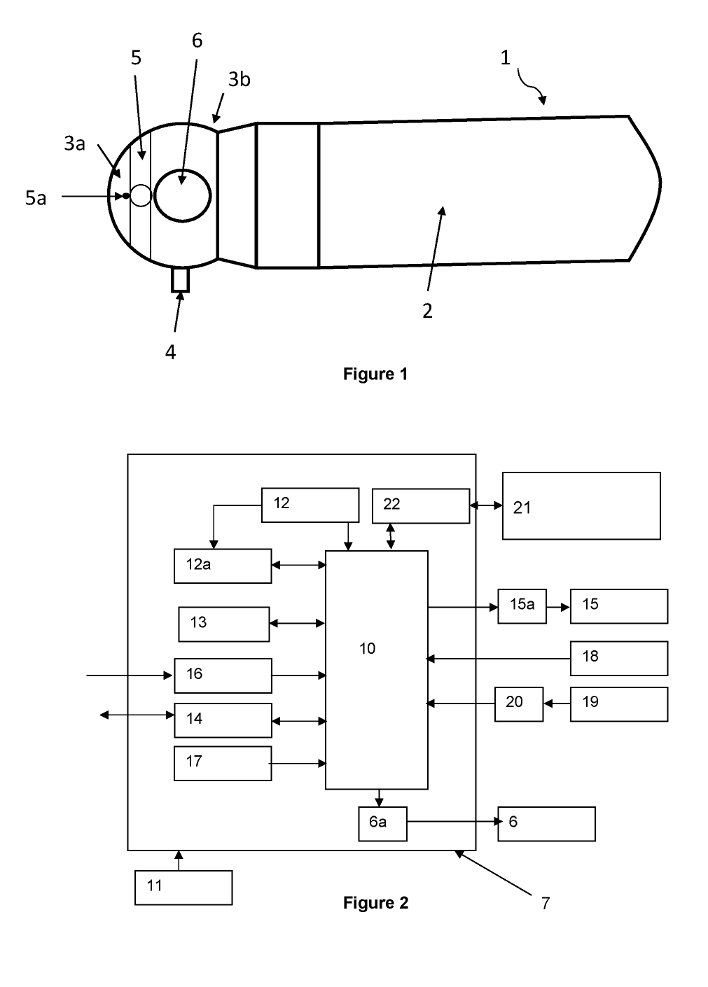

A lightweight compressed gas cylinder 1 for use in delivering medical gas therapy to patients is shown in FIG. 1. The compressed gas cylinder 1 generally comprises a hollow main body 2 in which therapeutic gas is stored under pressure; a cylinder head 3; a gas outlet 4; a flow scale 5; and a display 6. The hollow main body 2 is preferably made of an aluminium alloy liner strengthened with fully-wrapped bonded fibre on the outside. In a particularly preferred embodiment the aluminium liner is made using the proprietary L7X alloy of Luxfer Limited. To ensure that the gas cylinder is portable and can be carried easily by an ambulatory patient the illustrated cylinder has a gas capacity equivalent to 1 litre of water; a length preferably less than 50 cm, more preferably around 35 cm; a diameter preferably not more than 12 cm, more preferably below 10 cm, more preferably still between 7.5 cm and 9.5 cm; and weighs, when full, preferably not more than 2.5 kg, more preferably not more than 2.2 kg, and, when empty, preferably not more than 2 kg, more preferably below 1.5 kg, more preferably still below 1.14 kg. Of course, the capacity and dimensions of the cylinder may be different to those set out above.

A regulator valve (not shown), which is used to control the rate of flow of gas from the cylinder, is mounted within the cylinder head 3 and is in fluid communication with the gas outlet 4. The gas outlet 4 is adapted for connection to a gas supply line or other gas dispensing device. The rate of flow of gas from the cylinder 1 is adjusted by rotation of an upper section 3a of the cylinder head about the main axis of the gas cylinder 1 which adjusts the regulator valve within the cylinder head 3. The flow scale 5 is mounted to or printed on a fixed lower section 3b of the cylinder head relative to which the upper section 3a of the cylinder head can be rotated. The upper section 3a includes a marker 5a adjacent the flow scale 5 so that as the upper section 3a is rotated to adjust the rate of gas flow the marker 5a moves relative to the flow scale. The marker's position relative to the flow scale therefore indicates the rate of gas flow out of the cylinder.

The cylinder head 3 also includes a display 6 which provides information on the time remaining before full depletion of the gas within the cylinder 1. The display 6 may additionally provide status information such as, but not limited to, usage time, battery status, gas pressure, gas temperature etc. The display 6 may be an analogue display or a digital display or a combination of both analogue and digital. The display 6 is controlled by a micro-controller in the form of an electronic gauge 7 which is mounted within the cylinder head 3 and is described in greater detail below.

As shown in FIG. 2, the electronic gauge 7 generally comprises a central processing unit (CPU) 10, which includes one or more analogue-to-digital converters (ADC). The CPU 10 is in communication with the following: a timing device 12, such as a clock; one or more counters in the form of timers 12a; one or more memories 13 for example RAM and flash ROM (for the sake of clarity a single collective memory area is illustrated in FIG. 2); a display driver 6a; input/output interfaces including a communications interface 14 and a user input interface 16; and a temperature sensor 17. In addition, the electronic gauge 7 is in communication with the display 6 via the display driver 6a; an alarm 15 via an alarm driver 15a; a local power source 11 for example a battery; a regulator valve sensor 18; and a pressure sensor 19 via an instrumentation amplifier 20; and a telecommunication chip 21 preferably with an embedded radio for short distance wireless communication via a second communications interface 22. The CPU 10 of the electronic gauge 7 is preferably a low power, on-board memory processor, such as the Freescale™ MC9SO8 8-bit family of processors, programmed to perform the particular functionality described herein. The other components of the electronic gauge 7 are preferably conventional off-the-shelf components.

The battery 11 is preferably a single lithium manganese dioxide coin cell such as a CR2430. It will, though, be apparent that alternative local power sources may be used in the alternative. The local power source 11 is intended to be replaceable but preferably only by authorised personnel. Therefore, the local power source is preferably mounted within the cylinder head in a manner that permits access only with a specialised tool.

The clock 12 on the electronic gauge 7 is conventional in design and provides timing signals for operation of the CPU 10 and the associated components.

The communications interface 14 may include a simple serial connection or USB port. The telecommunication chip 21 includes a transmitter for wirelessly transmitting cylinder data including gas usage data to a remote receiver. Bluetooth™ is the preferred wireless communication system used by the transmitter but alternative wireless communication systems may also be used in the alternative.

The display 6 may include provision for a visual alarm in the form of a dedicated alarm icon and/or causing the display 6 to flash. Alternatively or in addition a separate flashing or continuous light may be provided. An audible alarm may also be provided by the alarm 15 preferably in the form of a piezoelectric buzzer. The alarm is used to alert patients to a cylinder leak and/or to the battery running low on power and/or to the gas in the cylinder being close to fully depleted i.e. equal to or below a time threshold or a gas remaining threshold.

The user input interface 16 includes one or more user activated keys such as, but not limited to, a membrane keypad. The user input interface enables a patient to perform one or more of at least the following actions: mute/cancel any alarms that have been triggered; set a real time clock function; and instruct wireless transmission of data to a data storage device.

The display 6 is preferably a continuous display such as an LCD display. The display 6 provides information on the calculated time remaining for a patient to continue to draw gas from the cylinder at the current flow rate before the cylinder becomes fully depleted. The time remaining may be presented as a simple numerical value expressed in minutes or hours and minutes. Additionally the display 6 preferably includes a graphical scale of between 0 and 100% representing the amount of gas remaining in the cylinder as a percentage of the maximum amount of gas. The resolution of the scale is preferably 5%, more preferably 2.5%. 0% is chosen to equate to 0-50 bar and 100% to 300 or 400 bar which is the standard operating pressure range for a medical gas cylinder for home use. The display 6 may also include information such as, but not limited to, battery status, duration of gas usage since the cylinder valve was last opened, the status of any wireless link and/or an alarm symbol or in the case of imminent gas depletion the word “LOW”.

As mentioned earlier the temperature sensor 17 is preferably embedded in the micro-controller 7. Alternatively, the temperature sensor 17 may be mounted adjacent the gas outlet 4 or as part of the regulator valve. The temperature sensor 17 is used to monitor the temperature of the cylinder and so indirectly the gas within the cylinder. An example of a suitable separate temperature gauge is Maxim DS18B20. Particularly for the case where the temperature sensor is mounted close to the gas outlet, the output of the temperature sensor 17 may be adjusted to take account of the cooling effect to the gas as it emerges from the cylinder outlet 4. The temperature sensor 17 preferably has an accuracy of ≦±2° C. and a range of −10 to +50° C.

The regulator valve sensor 18, which may consist of a simple electrical contact sensor or magnetic sensor, is provided to detect whether the regulator valve is open or closed. This information is communicated to the CPU 10 for the purposes of monitoring for gas leakage.

Ideally the pressure sensor 19 is a piezoresistive pressure sensor preferably with a standard sensor range up to 400 bar, an overload pressure around 600 bar and a burst pressure not less than 600 bar. The amplifier 20 amplifies the signals from the pressure sensor 19 for normal processing by the CPU 10. Where the pressure sensor 19 exhibits an offset error, an offset correction voltage may be injected into the amplifier 20 to adjust for the sensor's offset error.

In use, the upper section 3a of the cylinder head is rotated to open the regulator valve to the desired flow rate. This causes the regulator valve sensor 18 to flag that the valve is open. The pressure of the gas flowing to the cylinder is monitored by the pressure sensor 19 and the pressure readings are communicated to the CPU 10. In addition, the temperature of the gas is monitored by the temperature sensor 17 and the temperature readings are also communicated to the CPU 10. Additionally, the opening of the regulator valve may be time stamped as an event in the memory 13 along with selected gas flow rates as part of a record of usage of the gas cylinder.

Sequential pressure readings are recorded by the pressure sensor 19 and a plurality of the pressure readings are then averaged by the CPU 10 to determine a pressure sensor value. In the preferred embodiment 8 individual pressure readings are recorded every second and a pressure value (being an average of the pressure readings) determined every minute. Of course, the calculation of an average may be omitted. Where an average is calculated other time intervals between readings and other time ranges over which the average value is determined may be adopted. The CPU 10 then uses the pressure value to determine a cylinder pressure and in doing so the CPU 10 may apply any necessary gain and offset calibration corrections.

Sequential temperature readings are recorded by the temperature sensor 17. In the preferred embodiment 8 sequential temperature readings are recorded every second but other time intervals between readings may also be used. A plurality of the temperature readings are then combined by the CPU 10 using a function to determine a temperature value. In determining the temperature value the CPU 10 may also apply any necessary conventional gain and offset calibration corrections. The characteristics of the function used to determine the temperature value is described in greater detail later.

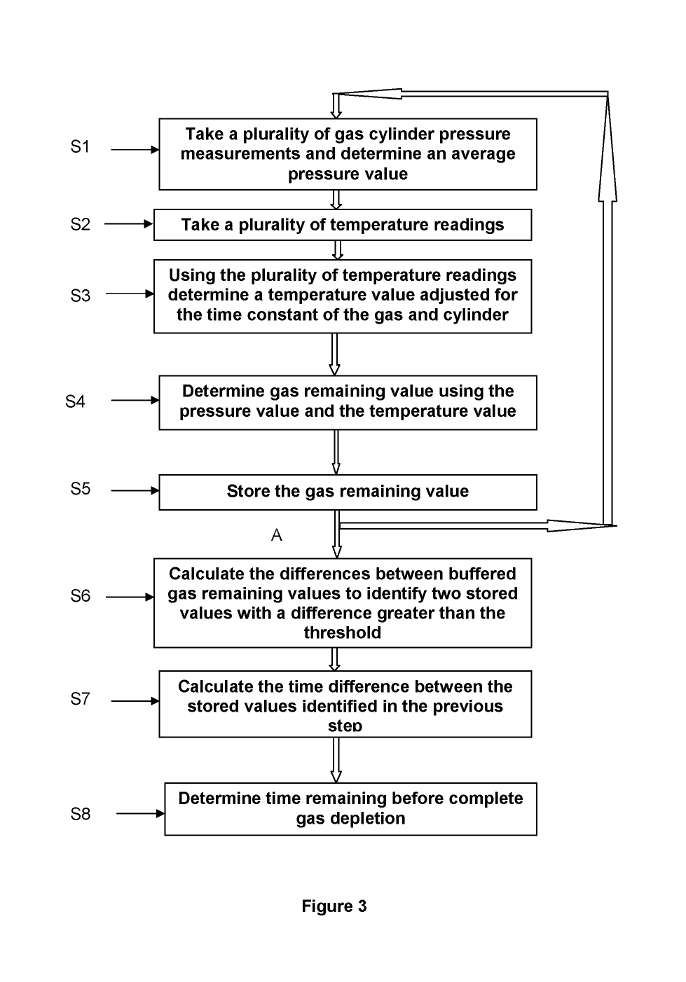

FIG. 3 illustrates the method steps performed by the CPU 10 in calculating the time remaining before full gas depletion. As mentioned above, with the regulator valve open firstly a plurality of pressure readings are recorded and averaged to determine a pressure value S1. A plurality of temperature readings are also recorded S2 and are used to determine a temperature value S3. The pressure value and the temperature value are then used in combination with the known volume of the cylinder main body to determine the current quantity of gas remaining n in the cylinder S4. The relationship between these variables is well-known for gases such as oxygen and other medical gases. The current quantity of gas determined to be remaining in the cylinder and its change in value Δn is then extrapolated to determine the amount of time it will take for the remaining gas to be fully depleted S8. The values mentioned above are determined repeatedly for different groups of sensor readings, so that a regularly updated value for time remaining is determined and can be displayed.

As the value of Δn is derived from measured physical quantities it is subject to errors and noise. Too small a value of Δn risks the calculation becoming ill-conditioned. Conversely, larger values of Δn require larger time intervals, ΔT, which means that the calculation of gas time remaining factors in more historical rates of change and if the depletion rate has changed during ΔT then the calculation of gas time remaining may become inaccurate. In summary, a balance between the value of ΔT (time interval) and the value of Δn (change in gas remaining) is required to ensure the calculated gas time remaining Tᵣₑₘ is accurate.

A plurality of values, preferably sequential values, of the calculated gas remaining n are temporarily stored S5 each associated with the time of the sampling event tᵢ and the gas time remaining Tᵣₑₘ is calculated according to Equation 1 below.
Δn is calculated: Δn=nᵢ−nᵢ₋ₓ, where −Δn≧gas difference threshold,
ΔT is calculated (Tᵢ−Tᵢ₋ₓ), then

Tᵣₑₘ=−(nᵢ×ΔT)/Δn Equation 1

The CPU 10 of the electronic gauge 7 described herein is adapted to calculate gas time remaining Tᵣₑₘ using a variable time period ΔT. Ideally, each calculation of Tᵣₑₘ employs the smallest value of ΔT where Δn exceeds the predetermined gas difference threshold S6, S7. For this purpose a FIFO (First-In-First-Out) buffer is preferred in calculating Tᵣₑₘ over a simple linear buffer. In both cases, however, the size of the buffer is chosen to ensure that it is capable of accommodating sufficient sequential values of n to enable Tᵣₑₘ to be accurately calculated at the lowest cylinder depletion rates. As identification of Δn is based on exceeding a gas difference threshold, the gas pressure measurements used in the calculation of values for Δn may be recorded over different and varying time periods.

The method steps described above rely upon a single predetermined minimum gas difference threshold to be achieved before the gas time remaining is determined. This mitigates the impact of errors and noise and improves the accuracy of the calculation of the time remaining. There is always a balance to be struck however in determining the threshold value: measurement inaccuracies become more significant when a smaller difference between them is calculated, therefore favouring a larger threshold value; a larger threshold value on the other hand increases the time period between values used in the calculation, with a consequential slower response to any changes in gas flow. A refinement of this method, described below, allows for the balance to be shifted, depending on the risk of the consequences of inaccurate measurement or slow change response.

The most inaccurate gas difference results are obtained when the gas pressure is highest and relatively small errors are amplified into large errors in the calculated time remaining. With this alternative method the predetermined minimum gas difference threshold is used in combination with a variable maximum gas difference threshold. The maximum gas difference threshold is varied in relation to the most recent gas pressure measurements.

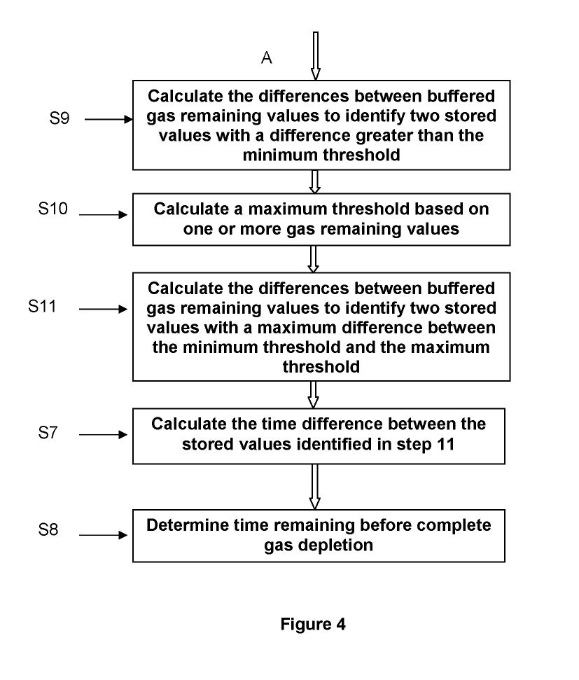

The alternative method employs the same initial steps to generate and store a plurality of gas remaining values: up to point A in FIG. 3. In other words steps S1 to S5 are the same and from point A onwards the alternative method is illustrated in FIG. 4. Thus, once a plurality of gas remaining values have been stored differences between pairs of gas remaining values are determined and compared with a predetermined minimum threshold S9. As described above, the minimum difference threshold is selected to mitigate errors arising from the difference being so small as to be ill-conditioned. For example, the minimum difference threshold is preferably set to be 2% of the maximum operating pressure of the cylinder. Thus for a 300 bar cylinder, the minimum difference threshold is 6 bar. Assuming there is a flow of gas from the cylinder, successive temperature and pressure measurements are taken and calculated gas remaining values are buffered to memory but no determination of the gas time remaining is carried out until sufficient gas has escaped the cylinder to exceed the minimum difference threshold. Once the minimum difference has been achieved, stored gas remaining values with a difference greater than the minimum threshold are identified.

At step S10, if the gas remaining value is greater than a particular value, for example 100 bar in a 300 bar cylinder, a maximum difference threshold is calculated. The maximum difference threshold takes account of the pressure regime in which the gas cylinder is currently operating and so is variable with respect to the most recently recorded gas pressure measurements. With the particular embodiment described herein and for a cylinder with a maximum operating pressure of 300 bar, the maximum difference threshold varies linearly with respect to the most recently recorded gas remaining value between a first value of 2% (i.e. coincident with the minimum threshold value) at a gas remaining value of 100 bar up to a second value of 6% at a gas remaining value of 300 bar. Thus, where the most recently recorded gas remaining value is 200 bar, the maximum difference threshold is set to 4% of 300 Bar namely 12 Bar. Other changing threshold patterns can, of course, be adopted

The differences between gas remaining values in the memory 13 are then compared at step S11 against the maximum difference threshold previously calculated to identify the pair of gas remaining values with the largest difference that is greater than the minimum difference threshold but equal to or less than the calculated maximum difference threshold. The pair of gas remaining values identified in step S11 is then used in the calculation of the time remaining (steps S7 and S8). With this alternative embodiment the time remaining will not always be calculated using the first pair of gas remaining values that exceed the minimum threshold. Instead where the gas remaining values are stored, for example, in a buffer, once a pair of gas remaining values is found that exceeds the minimum threshold the CPU continues to look back to earlier gas remaining values in the buffer to find the gas remaining value which has the greatest difference (below a calculated difference threshold) with respect to the most recent gas remaining value.

This alternative embodiment has the advantage in that initially, when the regulator value is first opened, time remaining estimates are generated as soon as gas pressure differences exceed the 2% threshold but these estimates improve in quality as further pressure measurements are taken and greater gas pressure differences are obtained (whilst the earliest gas remaining value from which the differences are calculated remains in the buffer). Moreover, as the cylinder empties and time remaining becomes less and so more critical, the maximum threshold is lowered until it coincides with the minimum threshold. At this point, the values used to calculate time remaining are as close as permitted temporally and the time remaining calculation is more responsive to variations in gas flow.

Further alternative embodiments are envisaged for determining the minimum and maximum difference thresholds for use in mitigating the effects of errors in the raw gas pressure measurements. In all cases, however, calculation of the gas time remaining is not constrained to a predetermined elapsed time between the earliest gas pressure measurement and the most recent gas pressure measurement used in the calculation of the gas time remaining.

The above calculations assume that the gas temperature remains substantially the same throughout. However, in the case of ambulatory patients carrying a lightweight cylinder it is likely that there will be occasions when the gas cylinder will be moved from a warm environment (e.g. within the patient's home) to a cold environment (e.g. outside on a cold day) or vice versa. With a small sampling time interval, there is a risk that the temperature sensor 17 will detect an environmental temperature change much more quickly than the temperature of the gas within the cylinder will adjust to the new temperature. In these circumstances the temperature sensor 17 will supply a temperature reading to the CPU 10 that is not representative of the actual temperature of the gas and which will distort the calculation of the amount of gas remaining.

To address this problem the time constant τ of the thermal body consisting of the cylinder and the gas within it is modelled and substantially matched to the function used to determine the temperature value from the plurality of temperature readings. Modelling of the time constant τ of the thermal body is based on the following equation:

t=(ρcₚV)/(hAₛ) Equation 2

where ρV is the mass of the body, cₚ is the heat capacity of the body, h is the heat transfer, and Aₛ is the surface area of the body.

In practice, preferably a Finite Impulse Response (FIR) filter or an Infinite Impulse Response (IIR) filter is used to determine the temperature values from the temporally separated (preferably sequential) temperature readings. The response of the filters is substantially matched to the response of the thermal body in the time domain to a temperature difference and in the case of an IIR filter, the filter response may be matched to the first order of the thermal body's response in the temporal domain to a temperature difference or to a higher order if, in doing so, this improves the accuracy of the determined temperature values.

In an alternative approach to addressing the problem resulting from sharp changes in environmental temperature, a series of cascading buffers may be used with the temperature readings stored in each buffer weighted with the weightings of each of the buffers selected to substantially match the time constant τ of the thermal body.

A further alternative approach to addressing the problem resulting from sharp changes in environmental temperature, is to increase the time interval between temperature readings and/or the time period over which each temperature value is determined so that the time interval or time period is greater than the time constant of the thermal body of the gas and cylinder.

Gas time remaining is repeatedly calculated using the methodology described above whilst the regulator valve is opened. When the regulator valve is closed, theoretically the gas time remaining is infinite and so need not be calculated. However, when the regulator valve is closed gas pressure within the cylinder continues to be monitored. If pressure changes (not arising from temperature changes) are detected whilst the regulator valve is closed this can trigger an alarm as the pressure changes are assumed to signal gas leakage.

In contrast to conventional portable pressurised gas cylinders which include data on gas remaining before full depletion, the gauge described above is much more accurate than such conventional pressurised gas cylinders and in particular is capable of mitigating the effects of sharp and substantial temperature changes. Moreover, all of this can be achieved in a compressed gas cylinder which is sufficiently lightweight that it can be easily carried by a patient thereby significantly improving their mobility and the likelihood of a patient accurately and consistently following a prescribed therapeutic regime of medical gas inhalation.

Although the gas cylinder described above is a lightweight pressurised cylinder particularly suited for use by ambulatory patients, it will be immediately apparent that the components and methodology for calculating gas time remaining described herein may be applied to any pressurised gas cylinder. Therefore the present invention as defined in the accompanying claims is not limited to a particular type, volume, size or weight of cylinder nor to the type of pressurised gas supplied by the cylinder. Similarly, the position of the regulator valve and the manner of controlling the rate of flow of gas from the gas cylinder is not limited to the particular embodiment described herein and alternatives are envisaged. For example, the present invention is also applicable to pressurised cylinders used for alternative fuel, industrial gases, SCBA, SCUBA etc. Similarly the present invention may be used with monolithic and hoop wrap cylinders. In the case of a monolithic cylinder the standard operating pressure for the cylinder is 200 bar, whereas the standard operating pressure is 230 bar for a BOC L7x HW and 300 bar for full wrap cylinders.

Moreover the present invention is suitable for retro-fitting to existing cylinders such as, but not limited to, 1 and 2 litre hoop wrap cylinders.

It will, of course, be apparent that one or more of the functional components of the micro-controller 7 described above may alternatively be provided as separate peripheral components. Similarly, functional components that have been described above as peripheral components may alternatively be integrated into the micro-controller 7. The display 6 is described herein as LCD display but alternative displays are also envisaged.

Furthermore, instead of repeatedly calculating the quantity of gas remaining in the cylinder as described above, in an alternative embodiment the CPU 10 may utilise a look-up table specific to the cylinder stored in the memory 13. In the look-up table a plurality of pressure sensor values may be stored each associated with one or more remaining gas quantities and one or more respective measured temperatures. In addition, with reference to Equation 1, where temperature values are each determined for the same predetermined time interval, ΔT may be calculated by multiplying the predetermined time interval by the number of sampling events minus 1.

The preferred methodology described above determines a pressure value using a plurality of pressure readings. It is envisaged that single readings of pressure may be used in the calculation of the gas remaining value.

It is to be understood that the embodiment described above is only one preferred exemplary embodiment. Changes may be made to the construction of the gas cylinder, the cylinder gauge and the method of calculating gas time remaining without departing from the spirit and the scope of the invention as claimed in the accompanying claims.

1. An electronic gauge for use with a compressed gas cylinder, the electronic gauge comprising:
one or more processing units adapted to receive gas pressure measurement from a gas pressure sensor and temperature measurements from a temperature sensor; and
a display interface in communication with the one or more processing units and adapted for communication with a display,
wherein the one or more processing units are adapted to perform the following steps:
i) determine a plurality of gas remaining values, each gas remaining value being based on a plurality of gas pressure measurements and one or more temperature measurements and
ii) determine a time remaining until substantially all gas in the compressed gas cylinder is depleted based upon two gas remaining values, and communicating the determined time remaining to the display interface for the display,
wherein, on each occasion when the time remaining until substantially all gas in the cylinder is depleted is determined, the one or more processing units are configured to use two gas remaining values which differ by at least a predetermined minimum gas remaining difference threshold.

2. An electronic gauge as claimed in claim 1, wherein when determining the time remaining until all gas in the cylinder is depleted the one or more processing units are not constrained to use two gas remaining values with a predetermined elapsed time between them.

3. (canceled)

4. An electronic gauge as claimed in claim 1, further comprising one or more memories in communication with the one or more processing units, the one or more memories including at least one FIFO buffer in which gas remaining values determined by the one or more processing units are temporarily stored.

5-6. (canceled)

7. An electronic gauge as claimed in claim 1, wherein the one or more processing units are configured to determine a gas remaining value using a temperature value determined by the one or more processing units, the temperature value being based on a plurality of temperature measurements, and using the pressure value determined by the one or more processing units, each pressure value being an average of a plurality of gas pressure measurements.

8. An electronic gauge as claimed in claim 7 wherein, to determine the temperature value, the one or more processing units are configured to apply to the plurality of temperature measurements a mathematical function which is substantially matched to the response in the time domain to a temperature difference of a thermal body consisting of the cylinder and the compressed gas within it.

9. An electronic gauge as claimed in claim 7 wherein, to determine the temperature value, the one or more processing units are configured to apply a Finite Impulse Response (FIR) filter or an Infinite Impulse Response (IIR) filter to the plurality of temperature measurements, the FIR filter or IIR filter having a response in the time domain that is substantially matched to the response in the time domain to a temperature difference of the thermal body consisting of the cylinder and the compressed gas within it.

10. An electronic gauge as claimed in claim 1, wherein the one or more processing units are further configured to determine a maximum difference threshold and for identifying a pair of gas remaining values for use in determining the time remaining, the pair of gas remaining values differing by an amount which exceeds the minimum gas remaining difference threshold and does not exceed the maximum difference threshold.

11-12. (canceled)

13. An electronic gauge as claimed in claim 1, further comprising a first data port in communication with the one or more processing units and adapted for communication with the gas pressure sensor.

14. An electronic gauge as claimed in claim 1, further comprising the temperature sensor or a second data port in communication with the one or more processing units and adapted for communication with the temperature sensor.

15-16. (canceled)

17. A compressed gas cylinder comprising a hollow main body in which is stored a gas under greater than atmospheric pressure; a cylinder gas outlet; a regulator valve for controlling the flow of gas from the hollow main body to the gas outlet; an electronic gauge in accordance with claim 1 and a display for displaying at least the time remaining until substantially all gas is depleted determined by the electronic gauge.

18. A compressed gas cylinder as claimed in claim 17, further comprising a valve sensor for monitoring at least adjustment of the regulator value.

19. A compressed gas cylinder as claimed in claim 17, further comprising the gas pressure sensor for recording gas pressure measurements within the main body.

20. A compressed gas cylinder as claimed in claim 17 further comprising the temperature sensor for recording temperature measurements.

21. A method of calculating time remaining until substantially all gas in a compressed gas cylinder is depleted, the method comprising the steps of:
(i) measuring on a plurality of temporally spaced occasions the pressure of gas in the cylinder;
(ii) measuring on a plurality of temporally spaced occasions the temperature;
(iii) determining gas remaining values, each gas remaining value being determined using a plurality of gas pressure measurements and at least one temperature measurement;
(iv) determining time remaining values, each time remaining value being the amount of time until substantially all gas in the cylinder is depleted; and
(v) displaying the determined time remaining values,
wherein in step (iv) on each occasion when the time remaining until substantially all gas in the cylinder is depleted is determined, two determined gas remaining values which differ by at least a predetermined minimum gas remaining difference threshold are used.

22. A method as claimed in claim 21
wherein in step (iv) selection of the two gas remaining values used in determining the time remaining value is not constrained to gas remaining values with a predetermined elapsed time between them.

23-24. (canceled)

25. A method as claimed in claim 21 further comprising the step of determining a maximum gas remaining difference threshold and wherein the step of determining gas time remaining values includes selecting a pair of gas remaining values differing by an amount which exceeds the predetermined minimum gas remaining difference threshold and does not exceed the maximum gas remaining difference threshold.

26. A method as claimed in claim 25 wherein the maximum gas remaining difference threshold is varied in accordance with the gas remaining value.

27. A method as claimed in claim 21, wherein each gas remaining value is determined using a temperature value and a gas pressure value and wherein the method further comprises the steps of:
determining a temperature value based upon a plurality of temperature measurements; and
determining a gas pressure value based upon an average of a plurality of gas pressure measurements.

28. A method as claimed in claim 27, wherein each temperature value is determined by applying to the plurality of temperature measurements a mathematical function which is substantially matched to the response in the time domain to a temperature difference of a thermal body consisting of the cylinder and the compressed gas within it.

29. A method as claimed in claim 28, wherein each temperature value is determined by applying to the plurality of temperature measurements a Finite Impulse Response (FIR) filter or an Infinite Impulse Response (IIR) filter, the FIR filter or IIR filter having a response in the time domain that is substantially matched to the response in the time domain to a temperature difference of the thermal body consisting of the cylinder and the compressed gas within it.

31. A method as claimed in claim 21, wherein the predetermined minimum gas remaining difference threshold is at least 2% of the maximum operating pressure of the compressed gas cylinder.
